(19) United States
(12) Patent Application Publication
(10) Pub. No.: US 2006/0118320 A1
(43) Pub. Date: Jun. 8, 2006

(54) Alignment arrangement for a circuit breaker cradle

(75) Inventors: Harry W. Josten, Grapevine, TX (US); Cliff A. Buxton, Bellefontaine, OH (US); Robert D. Meyer, Arlington, TX (US); Jason P. Wiant, Bedford, TX (US)

Correspondence Address: FOLEY & LARDNER LLP, 777 EAST WISCONSIN AVENUE, SUITE 3800, MILWAUKEE, WI, 53202-5308, US

(73) Assignee: Siemens Corporation

(21) Appl. No.: 11/007,056

(22) Filed: Dec. 8, 2004

(51) Int. Cl. H02G 3/08

(52) U.S. Cl. 174/50

(57) ABSTRACT

A method and an alignment arrangement for a circuit breaker cradle configured to mount in a switchgear enclosure. The switchgear enclosure includes a mounting base. The alignment arrangement includes a first cradle alignment notch defined in one end of the mounting base. A second cradle alignment notch is defined in another end of the mounting base. A first alignment tab is defined on one edge of the cradle and positioned on the cradle to align with the first cradle alignment notch. A second alignment tab is defined on another edge of the cradle and positioned on the cradle to align with the second cradle alignment notch. The two alignment tabs will mate and interlock with the two notches in the mounting base to align the cradle horizontally and vertically in the switchgear enclosure.

### FIELD

The present invention generally relates to the field of electrical switchboards and panel boards and more particularly to an alignment arrangement for a circuit breaker cradle configured to mount in a switchgear enclosure.

### BACKGROUND

Switchgear assemblies and switchboards and panel boards are general terms which cover metal enclosures, housing switching and interrupting devices such as fuses and circuit breakers, along with associated control, instrumentation and metering devices. Such assemblies typically include associated bus bars, interconnections and supporting structures used for the distribution of electrical power. Low voltage switchgear and switchboards operate at voltages of up to 600 volts and with continuous currents up to 5000 amps or higher. Such devices are also designed to withstand short circuit currents ranging up to 200,000 amps (3 phase RMS symmetrical).

Typical switchgear equipment is composed of a lineup of several metal enclosed sections. Each section may have several circuit breakers stacked one above the other vertically in the front of the section with each breaker being enclosed in its own metal compartment. Each section has a vertical or section bus which supplies current to the breakers within the section by short horizontal branch busses, also referred to as run-in busses. The vertical bus bars in each section are supplied with current by a horizontal main bus bar that runs through the lineup of metal enclosed sections. A typical arrangement includes bus bars for each electrical phase of a multi-phase system which may include three power phases and a neutral.

Circuit breakers used in switchgear enclosures may be of a stationary or a draw out construction. In a stationary construction, the circuit breaker is bolted to the structure both mechanically and electrically and is not removable without the use of tools. A draw out construction of a circuit breaker typically is removable without the use of tools. However, draw out breakers use plug-in electrical connections to the switchgear bus, generally referred to as primary disconnects, and are located at the rear wall of the circuit breaker compartment. In addition, the circuit breaker may have plug-in connections for control and communication wiring typically called secondary disconnects. In order to function properly, the draw out circuit breaker must rack in and out of the circuit breaker compartment without binding and with proper alignment of the primary and secondary disconnects to insure proper engagement for good electrical connection.

Thus there is a need for a switchgear enclosure for electrical equipment having at least one circuit breaker compartment for receiving a circuit breaker that will align the circuit breaker properly with the primary disconnects and secondary disconnects in the enclosure. There is a further need for an alignment arrangement for a circuit breaker cradle configured to mount in a switchgear enclosure that would align the cradle horizontally and vertically in the switchgear enclosure and align the cradle properly front to back within the switchgear enclosure. There is a further need for a circuit breaker cradle to be self aligning for installation in a switchgear enclosure.

### SUMMARY OF THE INVENTION

There is provided an enclosure for electrical equipment. The enclosure includes a pair of substantially parallel support members. At least one mounting base is coupled to the members, with the mounting base defining a first notch in the mounting base and a second notch in the mounting base. A cradle is configured to mount in the enclosure, with the cradle having a rear end defining a pair of mounting flanges, with each flange having at least one alignment tab corresponding to the respective notch. Wherein the cradle is supported in the enclosure and aligned in the enclosure by engaging the tabs with the notches and the cradle is aligned front to back by the flanges contacting the mounting base. Additional mounting bases can be installed with additional alignment tabs defined on the cradle corresponding to the additional mounting base notches. The circuit breaker cradle can be electrically grounded to the enclosure by metallic fasteners securing the cradle to the mounting base and extending into the frame members of the enclosure.

There is further provided an alignment arrangement for a circuit breaker cradle configured to mount in a enclosure. The enclosure includes a mounting base. The alignment arrangement includes a first cradle alignment notch defined in one end of the mounting base. A second cradle alignment notch is defined in another end of the mounting base. A first alignment tab is defined on one edge of the cradle and positioned on the cradle to align with the first cradle alignment notch. A second alignment tab is defined on another edge of the cradle and positioned on the cradle to align with the second cradle alignment notch. The two alignment tabs will mate and interlock with the two notches in the mounting base to align the cradle horizontally and vertically in the enclosure.

There is additionally provided a method for installing a circuit breaker in a switchgear enclosure, with the switchgear enclosure having a pair of vertical frame members. The method comprises the steps of providing a mounting base defining a first cradle alignment notch in one end of the mounting base and a second cradle alignment notch defined in another end of the mounting base. Coupling the mounting base to each of the vertical frame members. Providing a circuit breaker cradle, with the cradle having a rear end defining a pair of mounting flanges. Each mounting flange has at least one alignment tab with the tabs corresponding to the alignment notches. Coupling the circuit breaker cradle to the mounting base and each vertical frame member wherein the cradle is aligned horizontally and vertically by the tabs mating and interlocking with the notches and the cradle is aligned front to back by the flanges contacting the mounting base. Installing a circuit breaker in the cradle. Another embodiment of the method, the circuit breaker is a draw-out circuit breaker. Another embodiment of the method includes the steps of providing fasteners and installing the fasteners in the flanges, through the mounting base, into the vertical frame members, wherein the cradle is electrically grounded.

There is further provided an enclosure for enclosing electrical equipment. The enclosure includes a pair of spaced apart support members. At least one mounting base is coupled to the support members, the base including first and second alignment features. A cradle, including a third and fourth alignment feature, is alignable and engageable with the first and second alignment features respectively. The cradle is then aligned and supported in the enclosure when the alignment features are engaged.

### BRIEF DESCRIPTION OF THE DRAWINGS

FIG. 1 is a perspective view of an exemplary embodiment of a mounting base including notches of an alignment arrangement for a circuit breaker cradle.

FIG. 2A is a perspective view of an alternative exemplary embodiment of a mounting base including notches of an alignment arrangement for a circuit breaker cradle.

FIG. 2B is a detailed perspective view of the alignment notch defined in one end of the mounting base illustrated in FIG. 2A.

FIG. 3 is a perspective view of an exemplary embodiment of a circuit breaker cradle having a pair of mounting flanges with each flange having at least one alignment tab.

FIG. 4 is a partial plan view of the circuit breaker compartment including a mounting base and an additional mounting base with each mounting base defining notches of an alignment arrangement for a circuit breaker cradle.

FIG. 5 is a perspective view of a switchgear enclosure including several circuit breaker compartments and illustrating exemplary embodiments of circuit breaker cradles mounted in the circuit breaker compartments of the enclosure.

FIG. 6 is a top view of a circuit breaker cradle partially installed in a circuit breaker compartment of an enclosure with the flanges of the cradle not yet touching the mating surfaces of the mounting base and the tabs on the flanges not yet engaging the alignment notches in the mounting base.

FIG. 7 is a top view of the circuit breaker cradle illustrated in FIG. 6 with the circuit breaker cradle fully installed into the circuit breaker compartment, with the flanges of the circuit breaker cradle now touching the mating surfaces on the mounting base and the alignment tabs engaging the alignment notches in the mounting base and with fasteners securing the cradle to the mounting base.

FIG. 8 is a top view of the circuit breaker cradle illustrated in FIG. 7 with a circuit breaker installed in the cradle and contacting the primary disconnect apparatus of the circuit breaker.

### DETAILED DESCRIPTION OF EXEMPLARY EMBODIMENTS

Before describing the exemplary embodiments of an arrangement for aligning a circuit breaker cradle in a switchgear enclosure, several comments are appropriate. Switchgear assemblies and panel board assemblies typically include vertical (section) bus bars to distribute electric power within the enclosures. In a short circuit condition, extreme magnetic forces are created in the bus bars as a result of short circuit currents up to and including 200,000 amps symmetrical RMS flowing through each bus bar. In a three phase power system (typically) as a certain circuit current flows through such bus bars, magnetic forces between adjacent bus bars tend to move such bus bars laterally (perpendicular) to the current flow. The circuit breakers are installed in the switchgear enclosures to react to short circuit conditions and open the circuits to minimize damage to the enclosure and related electrical equipment.

One type of circuit breaker is referred to as a draw-out circuit breaker. A draw-out circuit breaker typically has plug in electrical connections to the bus bars in the enclosure and are typically referred to as primary disconnects. The primary disconnects are located on the rear wall of the circuit breaker compartment. Additional control wiring and communication wiring plug-in connections may also be provided and are referred to as secondary disconnects.

A draw-out circuit breaker compartment typically includes guide rails to locate and support the breaker in a racking mechanism for moving the breaker along the rails between the disconnect, test and connection positions. The circuit breaker compartments may also have additional features such as shutters and interlocks. The draw-out circuit breaker rails, racking devices and additional features may be housed in a separate framework referred to as a circuit breaker cradle 40. The circuit breaker cradle 40, when assembled into the switchgear enclosure 10, becomes a part of the circuit breaker compartment 15.

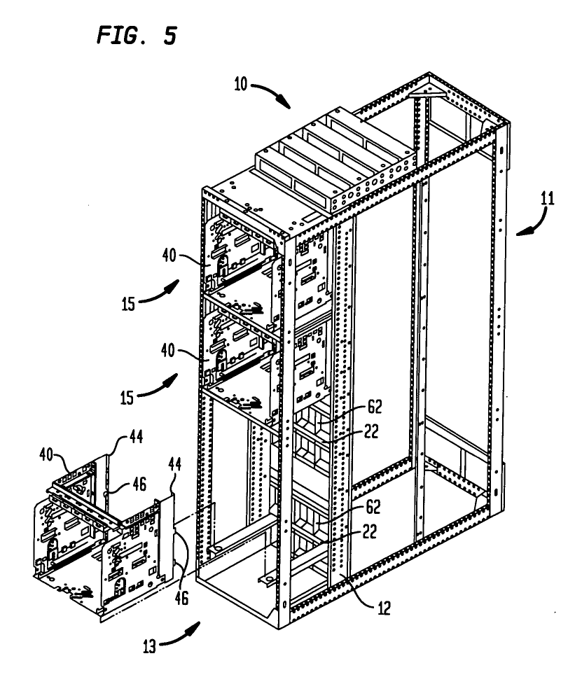

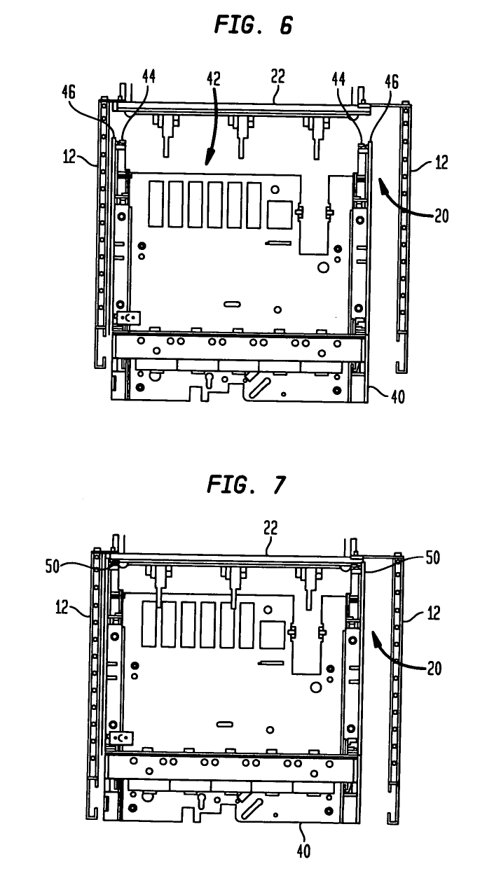

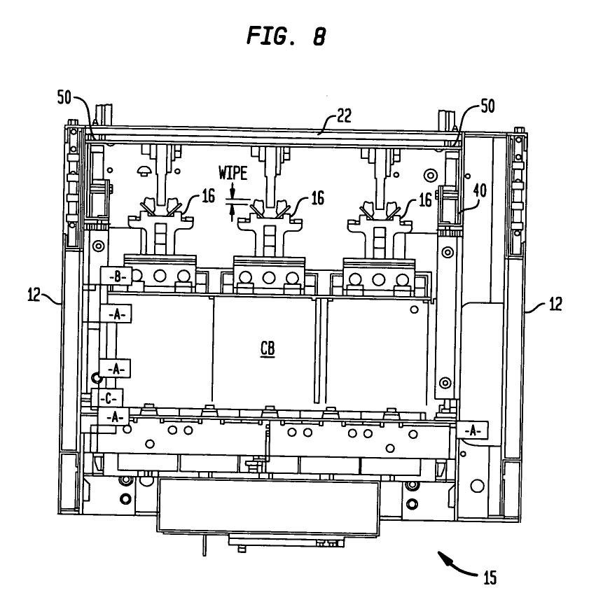

Referring now to the figures, FIG. 5 is an illustration of an exemplary embodiment of a switchgear enclosure 10 without several of the outer panels for clarity purposes. FIG. 5 also illustrates electrical equipment compartments 15 for circuit breakers. A mounting base 22 and an additional mounting base 62 form a part of the rear wall of the equipment compartment 15 and is coupled to several of the frame members 12, also referred to as support members of the switchgear enclosure 10, the support members being substantially parallel in the enclosure 10. In the illustrated drawing, the enclosure is configured for four circuit breaker compartments 15 and illustrates two cradles 40 installed in the enclosure 10. A typical switchgear enclosure 10 includes multi-phase switch gear assemblies conventionally having three power phases, A, B and C. A neutral bus or grounding bus can also be provided. Horizontal bus bars typically feed the main electric power to the enclosure 10 and adjacent enclosures (not shown) in a typical installation. Vertical bus bars coupled to the horizontal bus bars and coupled selectively to the circuit breakers and other electrical equipment in the enclosure 10.

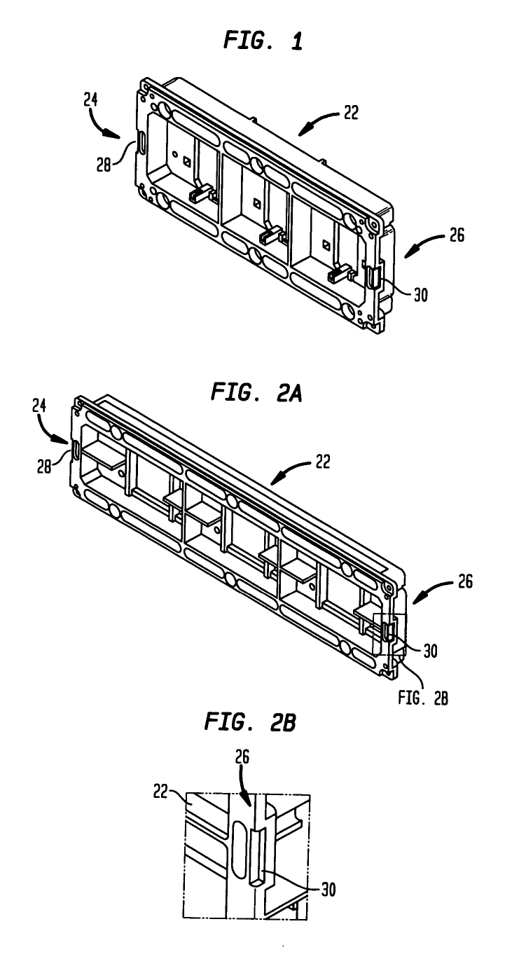

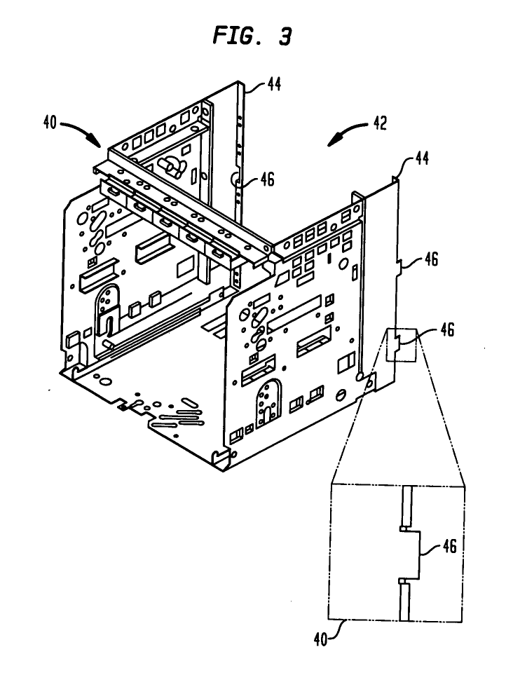

FIGS. 1 and 2A illustrate exemplary embodiments of a mounting base 22. FIG. 1 shows a typical base for a small frame draw-out circuit breaker, and FIG. 2A illustrates a typical base for a large frame draw-out circuit breaker. Each of the mounting bases 22 include a one end 24 and another end 26. A first cradle alignment notch 28 is defined in one end 24 of the mounting base 22 and a second cradle alignment notch 30 is defined in another end 26 of the mounting base 22. FIG. 2B illustrates a detailed view of a cradle alignment notch formed in the mounting base 22.

The mounting base 22, typically is a molded piece composed of electrically insulating material, such as thermoplastic, or glass reinforced polyester, or other suitable electrically insulating material that has a characteristic of the appropriate strength for the intended use. The alignment notches 28, 30 in the mounting base 22 are one component of the alignment arrangement 20.

FIG. 3 illustrates an exemplary embodiment of a circuit breaker cradle 40 for use with a draw-out circuit breaker CB. The circuit breaker cradle 40 includes a rear end 42 defining a pair of mounting flanges 44. Each mounting flange 44 has at least one alignment tab 46, also referred to as an alignment feature with the alignment tabs 46 corresponding to the alignment notches 28, 30, also referred to as alignment features defined in the mounting base 22. The circuit breaker cradle 40 can be fabricated from sheet steel by punching or cutting and forming. Other suitable materials can be used, such as engineered plastic or composite materials having adequate strength for the intended use. The alignment tabs 46 are typically fabricated when the mounting flanges 44 are formed. However, it should be understood that the alignment tabs 46 could also be welded or bolted on or attached by an adhesive or rivets as a separate operation, however, the preferred method is creating the alignment tab 46 when the mounting flange 44 is formed in the circuit breaker cradle 40.

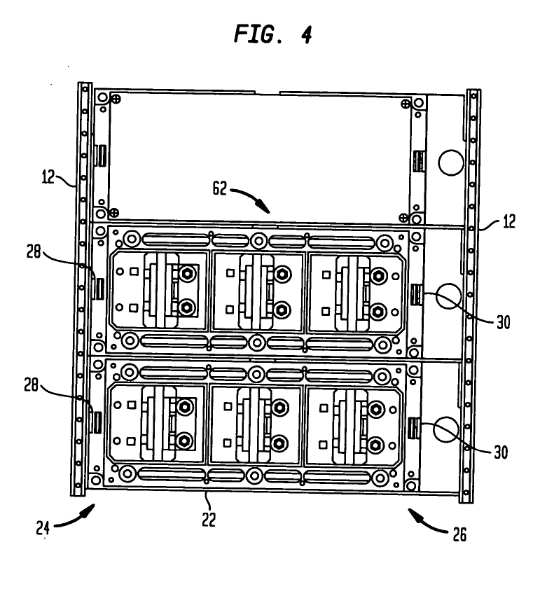

FIG. 4 illustrates an exemplary embodiment of the back wall of the circuit breaker compartment 15 formed with a mounting base 22 and an additional mounting base 64 positioned above the first mounting base 22. In the illustrated figure, a blank planar member is installed to complete the rear wall arrangement of the circuit breaker compartment 15. Each of the mount base 22 and the additional mounting base 62 define a first cradle alignment notch 28 and a second cradle alignment notch 30 in each of the respective mounting bases. The circuit breaker cradle 40 is installed in the circuit breaker compartment 15 with the alignment tabs 46 aligning with each of the cradle alignment notches 28, 30 in each of the mounting bases 22, 62. The alignment arrangement 20 self-aligns the circuit breaker cradle 40 as it is installed in the circuit breaker compartment 15 by the alignment tabs 46 mating with and interlocking with the cradle alignment notches 28, 30 in each of the mounting bases, 22, 62. Such arrangement aligns the cradle horizontally and vertically in the circuit breaker compartment 15. The circuit breaker cradle 40 is further aligned front to back within the circuit breaker compartment 15 by the mounting flanges 44 contacting the mating surfaces on the mounting bases 22, 62.

The circuit breaker cradles 40 are secured to the respective mounting bases 22, 62 with fasteners 50, such as screws or the like. The fasteners 50 are configured to extend through the mounting flanges 44 and into the mounting base 22, 62. The fasteners are also configured to pass through clearance holes formed in the mounting base and coupled to the frame members 12 of the enclosure to electrically ground the cradle 40 to the enclosure 10.

With the circuit breaker cradle 40 installed in the circuit breaker compartment 15, a draw-out circuit breaker CB can be installed in the circuit breaker cradle 40 in the circuit breaker compartment 15. (See FIG. 8.) The circuit breaker CB illustrated in FIG. 8 is positioned with the primary disconnect 16 engaging the switchgear primary disconnect blades of electrical bus bars in the enclosure 10. The amount of primary disconnect engagement, as illustrated in FIG. 8, is referred to as “wipe”. The wipe is set by the mating of the mounting flanges 44 of the circuit breaker cradle 40 with the front surface of the mounting bases 22, 62 and aligned laterally and vertically by the alignment tabs 46 and the respective cradle alignment notches 28, 30.

It should be understood that the size of the circuit breaker cradle 40 and the respective mounting bases 22, 62 are dependent upon the type of circuit breaker CB to be installed in the cradle 40 within the circuit breaker compartment 15. However, the alignment arrangement 20 described above will function with any appropriately side components described herein.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature

Thus, there is provided an alignment arrangement for a circuit breaker cradle to self-align and mount in a switchgear enclosure. The foregoing description of embodiments have been presented for purposes of illustration and description and is not intended to be exhaustive nor to be limited to the precise forms disclosed and modifications and variations are possible in light of the above teaching and may be acquired by practice of the invention. The embodiments are chosen and described in order to explain the principles and practical application to enable one skilled in the art to utilize the alignment arrangement in various embodiments and various modifications that are suited to the particular use contemplated. It is intended that the scope of the alignment arrangement be defined by the claims appended hereto and their equivalents.

What is claimed is:

1. An enclosure for electrical equipment, comprising:
a pair of substantially parallel support members;
at least one mounting base coupled to the members, with the mounting base defining a first notch in the mounting base and a second notch in the mounting base;
a cradle configured to mount in the enclosure, with the cradle having a rear end defining a pair of mounting flanges, with each flange having at least one alignment tab corresponding to the respective notch,
wherein the cradle is supported in the enclosure and aligned in the enclosure by engaging the tabs with the notches and the cradle is aligned front to back by the flanges contacting the mounting base.

2. The enclosure of claim 1, wherein the cradle is coupled to the support members by metallic fasteners, wherein the cradle is electrically ground to the enclosure.

3. The enclosure of claim 1, including at least one additional mounting base and at least two additional tabs defined on the cradle corresponding to the additional mounting base notches.

4. The enclosure of claim 1, wherein the tabs are integral with the mounting flanges as one piece.

5. The enclosure of claim 1, wherein the circuit breaker is a draw-out

6. An alignment arrangement for a cradle configured to mount in an enclosure, with the enclosure including a mounting base, the alignment arrangement comprising:
a first cradle alignment notch defined in one end of the mounting base;
a second cradle alignment notch defined in another end of the mounting base;
a first alignment tab defined on one edge of the cradle and positioned on the cradle to align with the first cradle alignment notch; and
a second alignment tab defined on another edge of the cradle and positioned on the cradle to align with the second cradle alignment notch, wherein the two tabs will mate and interlock with the two notches to align the cradle horizontally and vertically in the enclosure.

7. The alignment arrangement of claim 6, including at least one additional mounting base defining at least two additional notches and at least two additional tabs on the cradle aligned with the two additional notches.

8. The alignment arrangement of claim 6, including a pair of flanges on the cradle and configured to mate with a mating surface on each end of the mounting base, wherein the cradle is aligned front to back within the enclosure.

9. The alignment arrangement of claim 8, wherein the tabs are integral with the mounting flanges as one piece.

10. The alignment arrangement of claim 8, wherein the cradle is electrically ground by metallic fasteners coupled to the flanges and the enclosure.

11. A method for installing a circuit breaker in a enclosure having a pair of vertical frame members, the method comprising the steps of:
providing a mounting base defining a first cradle alignment notch in one end of the mounting base and a second cradle alignment notch defined in another end of the mounting base;
coupling the mounting base to each of the vertical frame members;
providing a circuit beaker cradle, with the cradle having a rear end defining a pair of mounting flanges, with each flange having at least one alignment tab, with the tabs corresponding with the alignment notches;
coupling the circuit breaker cradle to the mounting base and each 11 vertical frame member, wherein the cradle is aligned, horizontally and vertically by the tabs mating and interlocking with the notches and the cradle is aligned front to back by the flanges contacting the mounting base; and
installing a circuit breaker in the cradle.

12. The method of claim 11, wherein the circuit breaker is a draw-out circuit breaker.

13. The method of claim 11, including the steps of providing metallic fasteners and installing the fasteners in the flanges, through the mounting base, into the vertical frame members, wherein the cradle is electrically grounded.

14. The method of claim 11, wherein the tabs are integral with the mounting flanges as one piece.

15. The method of claim 11, including the steps of providing at least one additional mounting base defining at least two additional notches and providing at least two additional tabs on the cradle aligned with the two additional notches.

16. The method of claim 11, wherein the circuit breaker is a draw-out circuit breaker.

17. An enclosure for enclosing electrical equipment comprising;
a pair of spaced apart support members;
at least one mounting base coupled to the support members, the base including first and second alignment features;
and a cradle including a third and fourth alignment feature alignable and engageable with the first and second alignment features respectively, wherein the cradle is aligned and supported in the enclosure when the alignment features are engaged.

18. The enclosure of claim 17, wherein the cradle is configured to receive and align a draw-out circuit breaker.

19. The enclosure of claim 17, wherein the base is composed of an insulating material.

20. The enclosure of claim 17 wherein the cradle is electrically grounded to the support members.
